(19) United States
(12) Patent Application Publication
(10) Pub. No.: US 2021/0027295 A1
(43) Pub. Date: Jan. 28, 2021

(54) SYSTEM AND METHOD FOR IMPLEMENTING CARDLESS AUTHENTICATION

(71) Applicant: JPMorgan Chase Bank, N.A., New York, NY (US)

(72) Inventors: Joseph RAQUEPAW, Columbus, OH (US); Giancarlo MIRANDA, Columbus, OH (US); Sih LEE, Northvale, NJ (US); Joseph Bradley Nolan, Granville, OH (US); Matthew T. Muchter, Westerville, OH (US); Jeffrey Dean Mathwig, Worthington, OH (US)

(21) Appl. No.: 14/833,262

(22) Filed: Aug. 24, 2015

(51) Int. Cl. G06Q 20/40; H04W 4/00

(52) U.S. Cl. CPC G06Q 20/40; H04W 4/008

(57) ABSTRACT

The invention relates to a financial device comprising a reader that receives a request from a mobile device associated with a user for user authentication; an interactive display that displays confirmation of the request from the mobile device; a processor that retrieves an authentication code from the request and processes the authentication code to identify the user and associated privileges and restrictions specific to the user and the request; and a transaction processor that receives a transaction request from the authenticated user and performs the requested transaction in accordance with the associated privileges and restrictions.

### FIELD OF THE INVENTION

The invention relates generally to a system and method for cardless authentication, and more particularly to a system and method for providing authentication with a use code with customized restrictions and security features.

### BACKGROUND

Mobile banking technology allows customers to conduct numerous financial transactions through a mobile device. For instance, customers can use a mobile device to check account balances, pay third parties, and perform funds transfer. Because of the convenience, more customers are moving towards mobile banking. Along with mobile banking, consumers can use a mobile phone to pay for products and services instead of paying with cash or credit cards. As a result, customers tend to rely solely on a mobile device to perform most, if not all, transactions. More and more customers no longer carry physical cards. However, ATMs, banking kiosks, tellers, point of sale devices and other similar devices do not offer a convenient and secure authentication process that does not involve a physical card and some form of personal identification.

These and other drawbacks currently exist.

### SUMMARY

According to one embodiment, the invention relates to a financial device comprising a reader that receives a request from a mobile device associated with a user for user authentication; an interactive display that displays confirmation of the request from the mobile device; a processor that retrieves an authentication code from the request and processes the authentication code to identify the user and associated privileges and restrictions specific to the user and the request; and a transaction processor that receives a transaction request from the authenticated user and performs the requested transaction in accordance with the associated privileges and restrictions.

The method may be conducted on a specially programmed computer system comprising one or more computer processors, mobile devices, electronic storage devices, and networks.

The invention also relates to method for implementing a financial device for cardless authentication, the method comprising the steps of: receiving, at a reader, a request from a mobile device associated with a user for user authentication; displaying, via an interactive display, confirmation of the request from the mobile device; retrieving, via a processor, an authentication code from the request; processing, via the processor, the authentication code to identify the user and associated privileges and restrictions specific to the user and the request; receiving, via a transaction processor, a transaction request from the authenticated user; and performing, via the transaction processor, the requested transaction in accordance with the associated privileges and restrictions.

The computer implemented system, method and medium described herein can provide the advantage of cardless authentication, according to various embodiment of the invention. Customers do not need a physical card to interact with a ATM and/or other financial terminals. The innovative system and method provide a secure and convenient way for customers to extend entitlements to other users with customized restrictions and security features. Customers can also pre-stage transactions prior to ATM interaction thereby providing convenience and time efficiencies. Another advantage that can be provided is customer loyalty and retention due to the increased satisfaction of the account holder. The system provides convenience and security for customers as they transact with various financial devices. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram of a system for implementing cardless authentication, according to an exemplary embodiment of the invention.

FIG. 2 is an exemplary diagram of a method for implementing cardless authentication, according to an embodiment of the present invention.

FIG. 3 is an exemplary diagram of a method for implementing cardless authentication, according to an embodiment of the present invention.

FIG. 4 is an exemplary diagram of a method for implementing a pre-stage feature, according to an embodiment of the present invention.

FIG. 5 is an exemplary screenshot illustrating cardless authentication, according to an embodiment of the present invention.

FIG. 6 is an exemplary screenshot illustrating cardless authentication, according to an embodiment of the present invention.

FIG. 7 is an exemplary screenshot illustrating a pre-stage feature, according to an embodiment of the present invention.

FIG. 8 is an exemplary screenshot illustrating a pre-stage feature, according to an embodiment of the present invention.

FIG. 9 is an exemplary screenshot illustrating a pre-stage feature, according to an embodiment of the present invention.

### DETAILED DESCRIPTION

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention provides customer authentication using wireless, contactless, near field, radio and other communication technology. For example, an ATM with a reader (that supports wireless communication including NFC (near field communication), BLE (bluetooth low energy) WiFi, LTE, etc.) can authenticate a customer using a mobile phone or other device. The customer can use a one-time use code from a mobile app for authentication, the code may be communicated automatically between a mobile device and a reader associated with a financial terminal, e.g., ATM, etc. Also, the code may be manually entered by the user via a user interface on or associated with the financial terminal. The one-time use code may specify restrictions, constraints and/or parameters for the customer transaction. The customer may also pre-stage a transaction prior to a customer interaction with the financial terminal. Additional forms of security (e.g., biometric, user initiated actions, etc.) may be requested from the customer when necessary for fraud protection, enhanced security and/or identity verification. The customer authentication may be applied to an ATM, bank teller, financial adviser, merchant, service providers and/or other environments and applications.

An embodiment of the present invention is directed to cardless authentication at a terminal, such as an ATM, with a use code from a provider, e.g., financial institution, issuer, etc. The use code may be a code with an expiration time or time period that may be predetermined or variable. In this example, the use code may be used multiple times during a time period. Also, the use code may be used up to a threshold number of times, e.g., limit 5 authentications. According to an exemplary scenario, if customer does not have an ATM card, the customer may use a mobile application to access a one-time use code. At the ATM, the customer may then select from a menu which may include a selection, such as “Login with One-Time Use Code.” The customer may enter the one-time use code generated by a mobile app, other program or provided by another source. Additional security parameters may be implemented. For example, an embodiment of the present invention may match a geographic location (e.g., latitude and longitude coordinates, etc.) of a mobile device to the ATM location where the code is being used. If the mobile device's location does not match, then access to the ATM may be denied, restricted, impaired, flagged, etc. Also, the customer may be requested to provide an additional form of authentication, which may include a biometric, a PIN, password, alias, zip code, last four digits of a social security number, security question, and/or other information to supplement the one time use code. Other forms of additional authentication may also be requested.

An embodiment of the present invention is directed to pre-staging ATM transactions. Currently customers are generally required to first authenticate at an ATM and then use the ATM to make appropriate selections to reflect their desired transaction. This takes time for the customer to perform at the ATM and occupies the ATM for a long period of time, especially for more complex transactions. According to an embodiment of the present invention, customers may set-up a desired ATM transaction before the customer arrives at the ATM. The customer may set-up the transaction using a mobile app, mobile device, desktop device and/or other device. When the customer arrives at the ATM, the customer may authenticate with a card, cardlessly using a mobile device, a use code or other access code, then scan their phone on a reader, e.g., NFC reader. The ATM may then retrieve the desired transaction set up by the customer, the customer may confirm the desired transaction and the transaction may then be initiated.

An embodiment of the present invention is directed to cardless authentication at a terminal, such as an ATM, using a mobile payment application or mobile device. According to an embodiment of the present invention, an ATM with a reader, e.g., NFC reader, etc., may be used to authenticate a customer at an ATM without a card by using a mobile payment application. Another embodiment of the present invention is directed to ATM designs with a reader, e.g., NFC Reader. An embodiment of the present invention is directed to authenticating a customer device by establishing a communication channel based on close proximity with a receiving device, e.g., ATM, terminal, point of sale device, etc. The communication channel may involve near field communication, low energy proximity sensing, beacons, sensors, wireless technology, etc. An embodiment of the present invention is directed to authenticating a customer by establishing connectivity with the customer's mobile device. The connectivity may be established by various technologies, including proximity sensing, wireless and/or other communication technologies. For example, an ATM device may communicate with a customer's mobile device for authentication and then enable the customer to perform a set of functions. According to another example, a customer may approach an ATM or other device and the customer may interact with a NFC reader (e.g., the customer may tap a mobile phone to the NFC reader) associated with the ATM. In connection with the interaction, the customer may also provide a biometric. The biometric may be provided in various ways, including the customer placing his or her finger on the mobile phone's fingerprint reader, for example. Other forms of biometric or other methods of verifying identification may be implemented.

The following descriptions provide different configurations and features according to exemplary embodiments. These configurations and features may relate to providing financial services through financial services machines. While certain nomenclature and types of applications/hardware are described, other names and application/hardware usage is possible and the nomenclature provided is done so by way of non-limiting examples only. Further, while particular embodiments are described, it should be appreciated that the features and functions of each embodiment may be combined in any combination as is within the capability of one of ordinary skill in the art. The figures provide additional exemplary details regarding the present invention. It should also be appreciated that these exemplary embodiments are provided as non-limiting examples only.

Various exemplary methods are provided by way of example herein. These methods are exemplary as there are a variety of ways to carry out methods according to the present disclosure. The methods depicted and described can be executed or otherwise performed by one or a combination of various systems and modules. Each block shown in the methods represents one or more processes, decisions, methods or subroutines carried out in the exemplary method, and these processes, decisions, methods or subroutines are not necessarily carried out in the specific order outlined in the methods, nor is each of them required.

“Financial transaction machine” or “financial transaction device” as used herein, may include machines, devices, kiosks, and stations, each of which may be fixed or portable, for performing financial transactions with a financial institution. For example, financial transaction machines may include, but are not limited to, express banking kiosks (“EBKs”), automated teller machines (“ATMs”), personal teller machines (“PTMs”), financial self-service devices, financial services kiosks, financial transaction devices, portable electronic devices, money machines, cash machines, bank machines, and bancomats. Financial transaction machines may be located within or near a branch of a financial institution, a retailer, a merchant, or other public location. It should be appreciated that, while various exemplary embodiments are described herein in terms of an EBK, these descriptions are meant to be non-limiting and equally applicable to other forms of financial transaction machines. The financial transaction machine may be operated by a financial institution.

The term “financial institution,” as used herein, may include institutions that provide financial services to their members or customers. Financial institutions may include, but are not limited to banks, credit unions, trust companies, mortgage loan companies, insurance companies, investment banks, underwriters, and brokerage firms. The use of the term “bank” and “financial institution” herein is meant to be exemplary and non-limiting.

The term “customer,” as used herein, may refer to an individual who holds at least one account with the financial institution.

Traditionally, customers may have a physical form device used for access to a financial transaction machine that serves as a form of authentication. For example, the customer may have a card, such as a debit card, a credit card, or an EBK/ATM card, that is linked to a corresponding personal identification number (PIN). This card may be used to access the financial transaction machine to conduct a transaction. It should be appreciated that the use of the terms “debit card,” “ATM card,” and “credit card” are meant to be exemplary and non-limiting examples. Customers may swipe, dip, or otherwise present the card at the financial transaction machine and then enter the corresponding PIN to authenticate themselves, i.e., to confirm that they are the owners of the accounts associated with the presented card. This authentication may be required to conduct a transaction with the financial transaction machine. For one reason or another, a customer may not have the physical card (e.g., debit card or EBK/ATM card) with them when interacting with a financial transaction machine. For example, the customer may lack a physical card and/or physical identification. Accordingly, without the physical card, the customer is unable to conduct a transaction with the financial transaction machine. In such a case, the customer may use a mobile device to generate a use code, that provides customer authentication and thereby enables the customer to interact with the ATM or other device.

Exemplary embodiments provide methods and systems for conducting financial transactions with a financial transaction machine. A mobile application, such as one provided by a financial institution with which the customer has an account, may be used. The mobile application may be installed on a portable electronic device, such as a tablet, smartphone, wearable, etc. According to an exemplary embodiment, the customer may perform various banking and other functions using the mobile application.

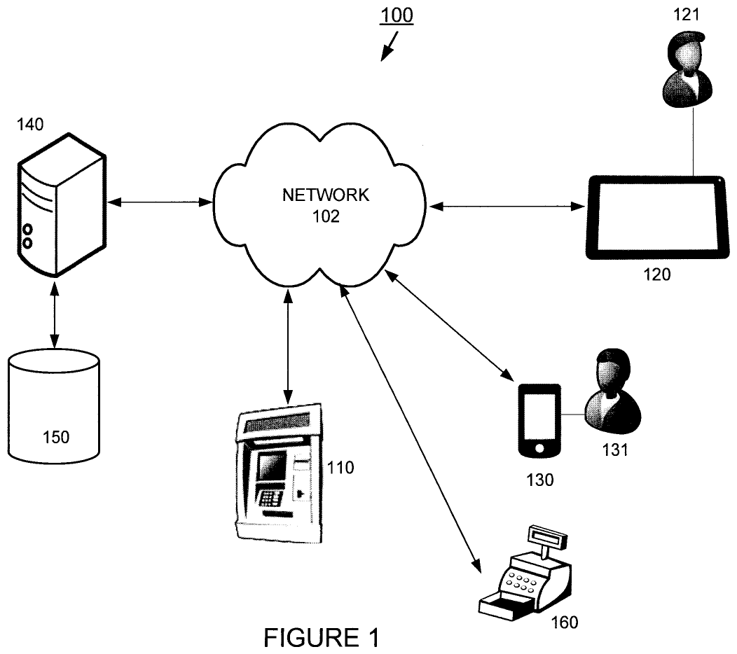

Referring to FIG. 1, a schematic diagram of a system 100 is shown, according to an exemplary embodiment. As illustrated, network 102 may be communicatively coupled with one or more data devices including, for example, financial transaction machine 110, tablet computing device 120, smart phone device 130, server 140, database 150, and point of sale device 160. The devices 120 and 130 may be associated with customers 121 and 131, respectively. The system 100 of FIG. 1 may be implemented in a variety of ways.

Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 is depicted, it should be appreciated that other connections and relationships are possible. The system 100 described below may be used to implement the various methods herein, by way of example. Various elements of the system 100 may be referenced in explaining the exemplary methods described herein.

The network 102 may be a wireless network, a wired network or any combination of wireless network and wired network. For example, the network 102 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, the network 102 may support an Internet network, a wireless communication network, a cellular network, Bluetooth, or the like, or any combination thereof. The network 102 may further include one, or any number of the exemplary types of networks mentioned above operating as a stand-alone network or in cooperation with each other. The network 102 may utilize one or more protocols of one or more network elements to which it is communicatively coupled. The network 102 may translate to or from other protocols to one or more protocols of network devices. Although the network 102 is depicted as one network for simplicity, it should be appreciated that according to one or more embodiments, the network 102 may comprise a plurality of interconnected networks, such as, for example, a service provider network, the Internet, a cellular network, corporate networks, or even home networks, or any of the types of networks mentioned above.

Data may be transmitted and received via network 102 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 1 shows a single financial transaction machine 110, tablet device 120, smartphone device 130, server 140, and database 150, it should be appreciated that there may be several of such devices to carry out the various exemplary embodiments. For example, the financial transaction device 110 may represent several EBKs, any one of which may be used to practice the various exemplary embodiments. Again, the use of EBKs is meant to be non-limiting and, may include, but are not limited to, automated teller machines (“ATMs”), personal teller machines (“PTMs”), financial self-service devices, financial services kiosks, financial transaction devices, portable electronic devices, money machines, cash machines, bank machines, and bancomats, for example. The financial transaction device 110 may be associated with and/or operated by a financial institution. The financial transaction machine may be connected directly with the financial institution, or indirectly using a payment network, processor, or gateway.

The financial transaction machine 110 may comprise, for example, a display, which may be touch-sensitive or otherwise; an alpha-numeric and/or QWERTY keyboard, either physical or virtual, for receiving input; a pointing device, such as a trackball, track wheel, or mouse, for example; a scanning camera to scan items displayed or presented by customers 121 and/or 131; a cash dispenser; a check and/or cash receiver; a printer, such as for printing receipts, for example; a biometric scanner, such as a fingerprint or retinal scanner; and communication chipsets for communicating with other devices, such as server 140, tablet device 120, and/or smartphone device 130, directly or via network 102, for example.

The financial transaction machine 110 may also include a reader (e.g., NFC, BLE, WiFi, LTE, etc.) to establish wireless communication with mobile devices. For example, a flat horizontally oriented NFC reader may communicate with phones having the NFC antenna in the middle of the phone. Also, a vertically oriented NFC reader may be used to establish communication with a mobile phone by pointing the top of another mobile device at the vertically oriented NFC reader. Financial transaction machines may support various designs that allow for ergonomic use of NFC capable phones with NFC enabled ATMs. Other forms of wireless, contactless and radio communications may be supported.

The tablet device 120 may be associated with a customer 121. The customer 121 may have one or more accounts with the financial institution that operates the financial transaction machine 110. The tablet device 120 may alternatively be a laptop computer, a personal digital assistant, a smartphone, a smartwatch, smart glasses, other wearables or other computing devices capable of sending or receiving network signals. The tablet device 120 may have an application installed that is associated with the financial institution.

The smartphone device 130 may be associated with a customer 131. The customer 131 may have one or more accounts with the financial institution that operates the financial transaction machine 110. The tablet device 130 may alternatively be a laptop computer, a personal digital assistant, a tablet device, a smartwatch, smart glasses, or other computing devices capable of sending or receiving network signals. The tablet device 130 may have an application installed that is associated with the financial institution.

It should be appreciated that while two customers, 121 and 131, are depicted in FIG. 1, in various exemplary embodiments, the system 100 may have a single customer, such as customer 121 or 131, or, in various exemplary embodiments, the system 100 may have a plurality of customers, beyond the two customers depicted. Each customer may have an associated portable electronic device, such as, for example, a tablet computing device and/or a smartphone. Each customer may interact with the system 100 in the manner described herein.

The server 140 may perform operations associated with processing information and data associated with the financial transaction device 110, the tablet device 120, and/or the smartphone device 130. The server 140 may comprise one or more servers and/or computers, each having one or more computer processors associated therewith. In various exemplary embodiments, the server 140 may be a specific computing device to support exemplary embodiments as described herein.

The server 140 may be communicatively coupled with the database 150. The database 150 may contain data and information used by the system 100. For example, the database 150 may store account data for customers 121 and 131, as well as customer profile data. The database 150 may also contain additional information related to the operation and administration of the system 100. The database 150 may include any suitable data structure to maintain the information and allow access and retrieval of the information. For example, database 150 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

The database 150 may be any suitable storage device or devices. The storage may be local, remote, or a combination thereof with respect to the database 150. The database 150 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). The database 150 may have back-up capability built-in. Communications with the database 150 may be over a network, such as network 102, or communications may involve a direct connection between the database 150 and the server 140, as depicted in FIG. 1.

The point of sale device 160 may be associated with a merchant. The merchant may have a relationship with the financial institution such that the point of sale device 160 may be communicatively coupled, through the network 102, with the server 140 and the database 150. In various exemplary embodiments, the point of sale device 160 may be a server associated with an e-commerce website through with customer's conduct on-line transactions. In various exemplary embodiments, the point of sale device 160 may be a physical device located at a merchant's location.

Having described an example of the hardware, software, and data that can be used to run the system, an example of the method and customer experience will now be described. The method will be described primarily as an example in which a customer downloads a software application (sometimes referred to as an “app”) and uses it to perform banking transactions and/or other functionality, including making purchases. However, those skilled in the art will appreciate that the principles of the invention can be applied to related circumstances, such as where the entity providing the app is a business other than a merchant, or where the merchant app functionality is provided through a browser on the customer's mobile device rather than through a software application (app) downloaded to the customer's mobile device, and with purchases from various providers.

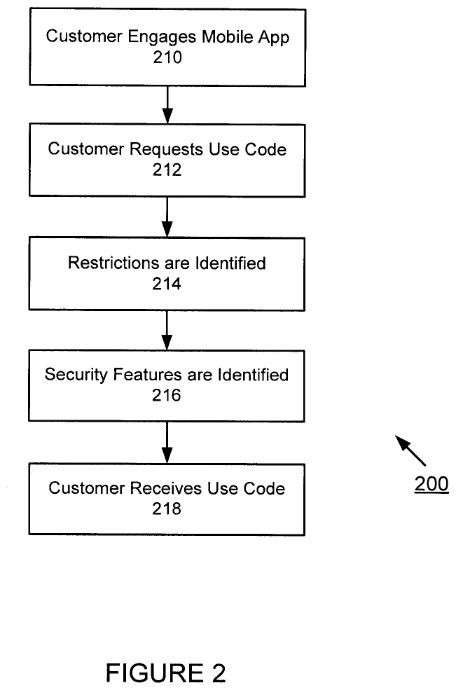

FIG. 2 is an exemplary diagram of a method for cardless authentication, according to an embodiment of the present invention. At step 210, a customer may engage a mobile application on the customer's mobile device. At step 212, the customer may request a use code for authentication. At step 214, one or more restrictions may be identified. At step 216, security parameters and/or features may be identified. At step 218, the customer may receive the use code. The order illustrated in FIG. 2 is merely exemplary. While the process of FIG. 2 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

An embodiment of the present invention is directed to leveraging a mobile device, e.g., phone, wearable, etc., physically at a financial device, e.g., ATM, to establish a communication channel between the mobile device and the financial device. The communication channel may be supported by various wireless technologies, including NFC, BLE, WiFi, LTE, cellular, radio, beacons and/or other communication technologies. Another method may include Quick Response (QR) code and/or other barcode, images, for example. Using the established communication channel, an embodiment of the present invention may identify the customer based on a signal, identifier and/or other data or information provided by the customer's device, for example.

At step 210, a customer may engage a mobile application on the customer's mobile device. A cardless authentication feature may be provided or offered by a financial institution, bank, service provider, government agency, merchant, third party entity, etc. An embodiment of the present invention may automatically provide cardless authentication feature to the customer. For example, if a customer is deemed to be in good standing, this feature may be automatically available to the customer. Also, the customer may request or otherwise activate this feature. In addition, a store clerk or other representative may inform the customer that this option is available and activate the feature for the customer during a purchase transaction. Other variations on activation may be implemented.

At step 212, the customer may request a use code for customer authentication. If the customer does not have a bank card and/or other form of identification, the customer may use a use code as a form of authentication. The use code may be a one-time use code, a use code with an expiration, a use code that is associated with a level of privilege and functionality. Other restrictions and features may be associated with the use code. The one-time use code may be generated, retrieved, selected and/or otherwise made available using a mobile app on a mobile device. The one-time use code may be a code that is unique to the system and may be randomly generated. Also, a use code may be provided once a customer's identity is verified. For example, a use code may be provided via a phone conversation, IVR, text message, SMS, email, a website (e.g., social media website, bank website, private message, etc.), in person, bank teller, merchant, service representative and/or other mechanism that is able to verify a customer's identity. Also, third party apps or channels may include merchant apps, social media apps, trusted groups and/or other third party apps.

The use code may be used, in whole or in part, to authenticate the customer at various devices, e.g., ATM device, bank teller, merchant, PoS device, website, telephone interaction, etc.

At step 214, one or more restrictions may be identified. An embodiment of the present invention may provide various different levels of restrictions for the one-time use code. The use code may be used once, or multiple times during a time period. The use code may have a geographic restriction, where the use code is only valid within an area, merchant, financial institution, and/or other qualifier. The use code may be geofenced or associated with geographic constraints. For example, the use code may only be valid in a market that corresponds to the area from which the code was requested. This may be based on the location of the mobile device at the time of the request. The location may also be predetermined, user defined, etc.

Other restrictions may include the amount of funds that may be transacted, how much money can be withdrawn, how many transactions, threshold dollar amount, etc. Restrictions may include type of transaction, time of day, frequency of transactions, budget constraints, etc. Also, an embodiment of the present invention may recognize a higher level of confidence and security for some customers, transactions, geographic locations, etc. For example, a customer may provide an additional level of authentication where the customer provides a biometric credential (e.g., fingerprint, facial expression, voice recognition, swipe pattern, etc.), answers one or more security questions, etc. This customer may then experience a higher level of privileges and may thereby override certain restrictions or constraints.

Restrictions may be defined by the customer. Also, restrictions may be automatically applied and may be further customized based on various factors, e.g., customer profile, geographic location, transaction history, fraud concerns, etc.

At step 216, security parameters and/or features may be identified. When the authentication process is deemed secure (or above a threshold level of security), the customer may be able to perform additional functionality and experience greater privileges and freedom. Also, an embodiment of the present invention may provide internal security analysis, e.g., carrier-level checks to confirm that the phone number belongs to the customer, device identification, location confirmation, etc. Based on the results of the internal security analysis, additional security measures may be implemented or not. For example, if a customer is unable to immediately verify or answer a security question, additional restrictions may apply. Rather, than cancelling access, an embodiment of the present invention may provide restrictions on the transaction (e.g., dollar limit, time limit, etc.) and/or closely monitor activity for potential fraud analysis.

At step 218, the customer may receive the use code. The use code may be provided on the customer's mobile device. It may be visible or not to the user. For example, the customer may receive confirmation that the use code has been received by the mobile device. The use code may be then be communicated to a receiving device for authorization. In this example, the user may or may not see the actual use code. According to another example, the user may manually input the use code to a receiving device. In yet another scenario, the user may initiate transfer of the use code to a receiving device, by selecting a transfer use code icon, for example.

An embodiment of the present invention is directed to ATM Designs with a NFC Reader. Various designs that allow for more ergonomic use of NFC capable phones with NFC enabled ATMs while maintaining a desirable aesthetic look and feel. Specifically, an embodiment of the present invention is directed to authenticating a customer device by establishing a communication channel based on close proximity with a receiving device, e.g., ATM, terminal, point of sale device, etc. The communication channel may involve near field communication, low energy proximity sensing, beacons, sensors, wireless technology, etc. For example, mobile devices may broadcast a signal, an identifier and/or other information to a nearby receiving device. This enables mobile devices, tablets, wearables, etc. to perform actions and/or communicate when in close proximity to a receiving device or terminal. An embodiment of the present invention is directed to authenticating a customer by establishing connectivity with the customer's mobile device. The connectivity may be established by various technologies, including proximity sensing, wireless and/or other communication technologies. For example, an ATM device may communicate with a customer's mobile device for authentication and then enable the customer to perform a set of functions.

The ATM device may also consider any entitlements that the customer has been granted and the associated approved actions. A bank teller may authenticate a customer's mobile device and enable the customer to perform a different set of functions as compared to when the same customer is authenticated with a ATM device. Also, the authentication process may be the same or varied based on the device or type of device that is performing the authentication. Likewise, the customer's privileges and functionality may be same or a variation thereof, based on the authenticating device. Moreover, associated fraud and/or security measures may be based on the authentication process as well as the authenticating device. For example, an in-person (e.g., bank teller) interaction may be deemed less risky than an ATM transaction. In this example, biometrics and other credentials may be readily verifiable during an in-person interaction.

According to another example, a customer may enter a merchant location. Because the customer has made in person transactions at the merchant location, the customer may be recognized from prior interactions or transactions. Accordingly, the customer may be authenticated through device communication or other authentication process. However, if the same customer visits another merchant for the first time, because the customer has no prior history, the customer's device may be used to authenticate the customer when the customer enters the merchant. According to another example, if the customer visits the same merchant but in a different store location for the first time, the customer may be recognized based on the customer's interaction at the other merchant location. The authentication data may be shared within a merchant organization as well as with affiliates, trusted parties, etc.

According to another example, an authentication of an embodiment of the present invention may enable a customer to purchase items without having to checkout or otherwise interact with a payment terminal or salesperson. For example, a customer may enter a merchant store with proximity technology. Because the merchant recognizes the customer based on the mobile device communication, the customer may select items for purchase, scan the items with the mobile device and then charge the amount to the customer's account.

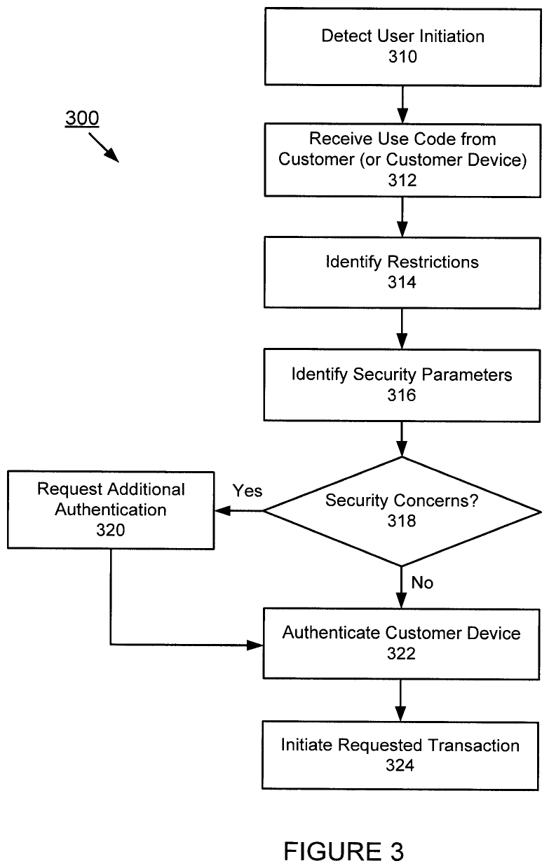

FIG. 3 is an exemplary diagram of a method for cardless authentication, according to an embodiment of the present invention. At step 310, an embodiment of the present invention may detect customer initiation of the cardless authentication feature. At step 312, an embodiment of the present invention may receive a use code from the customer. At step 314, the system may identify restrictions. At step 316, an appropriate level of security may be executed. At step 318, it may be determined whether there are any security concerns. If not, the customer device may be authenticated at step 322. If security concerns are detected, additional authentication requests may be made at step 320. At step 324, the requested transaction may be initiated. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

At step 310, an embodiment of the present invention may detect customer initiation of a cardless authentication feature. An embodiment of the present invention may automatically authenticate when a mobile device is within proximity or range of a reader or other receiving device, e.g., ATM device. Also, a customer may initiate a near proximity authentication process. Authentication may be automatically performed based on predetermined conditions. For example, a customer may enable cardless authentication whenever the customer enters a frequently visited branch location. Also, cardless authentication may be automatically activated for ATM transactions during a customer's work day.

At step 312, an embodiment of the present invention may receive a use code from the customer. The use code authentication may be provided by a customer at a terminal, e.g., ATM, kiosk, terminal, etc. The use code may be transmitted automatically from mobile device to receiving device. Also, the customer may manually enter the use code via an interface on or associated with the terminal. The customer may also initiate a transfer of the use code to the receiving terminal.

The use code authentication may be applied to various other environments, including a bank teller, merchant, airport, travel, government entities, hospital, medical services, and/or other scenarios that involve user authentication or confirmation of identity. For example, a customer may be in line for a bank taller. Instead of providing a bank account number and showing a driver's license, the customer may request a one-time use code and also provide a PIN (or other credential) to the teller. Accordingly, the customer may be authenticated without having to provide identification or an account number. This may also be used for telephone banking, online banking, and other types of electronic, in-person and other interactions. In another example, a user may provide a use code to authenticate the customer's identity during travel, in place of a plane ticket, train ticket, bus ticket, etc. Also, the use code may also enable a customer to gain access to buildings, areas, concerts, performances, etc.

The use code may be any identifier that can be used to uniquely identify or authenticate a customer. The identifier may include a series of number, symbols, words, images, icon, a combination of devices, pattern, swipe, etc. The use code may be entered by the customer via a reader, display, panel and/or other input or interface. Also, the use code may be transmitted by the mobile device to a reader or another receiving device. The customer may be aware or not aware of the transmission between device to device communications. For example, a mobile device may communicate a use code via NFC, BTE, over the air, etc. to a reader.

At step 314, the system may identify restrictions. The use code may be associated with restrictions, conditions, unique characteristics and/or other information. For example, the one-time use code may expire within a predetermined or variable time period after creation. The use code may be valid for only one transaction, a set number of transactions or transactions within a time period. Depending on the customer, the transaction, geographic location, timing and/or other considerations, a variable and/or customized expiration time or time period may be applied. For example, a customer may be in an area with a high rate of fraud or the customer may also have a history of fraud issues. In such cases, the expiration time may be shorter. For other customers or transactions with low risk, the expiration time may be longer to provide convenience to the customer. The customer may also request a longer expiration time for flexibility. In this example, the expiration time may be a day or more.

An embodiment of the present invention may consider customer specific data in identifying privileges and/or restrictions. For example, if the customer is a valued customer, the customer may be given additional privileges and functions upon authentication. Other factors may be considered, including the customer's transaction history, spend level, prior fraud incidents, peer data, credit history, current balance, etc. Also, data relating to the current interaction may be considered in determining privileges and restrictions. For example, if the authentication is for a ATM device instead of an in-person interaction, additional restrictions may be applied.

At step 316, an appropriate level of security may be executed. The security analysis may include device authentication, which may also include carrier level analysis.

According to another exemplary scenario, a customer may conduct a card transaction at a merchant location. The card issuer may request verification. The customer may request a use code, which may be delivered via a mobile app, text message and/or other form of communication. The use code may be delivered directly to the merchant. For riskier transactions (e.g., online purchases, etc.), additional forms of authentication may be requested or required. An embodiment of the present invention may then push out a secure mobile alert to the mobile device once the device has been confirmed to be a trusted device. The customer may receive a security alert, which may include a confirmation request to verify that the customer is aware of the card transaction. The mobile device may receive a message “You're about to make a transaction at merchant X, please confirm this transaction is authorized.” Accordingly, an embodiment of the present invention may identify transactions of high value and/or high risk and in response, implement an appropriate security feature.

At step 318, it may be determined whether there are any security concerns. If not, the customer device may be authenticated at step 322. If security concerns are detected, additional authentication requests may be made.

At step 320, if appropriate, additional authentication may be requested and/or other security measures may be implemented. Other forms of identification and/or authentication may be implemented, including biometrics, fingerprint, voice recognition, facial recognition, facial gesture/expression, pre-selected image, security question, a personal identification number, debit card PIN, zip code, digits from a social security number, etc. Also, a customer may perform a personalized swipe pattern or provide another personal input on a screen of an ATM and/or screen of an associated mobile device. Other forms of confirmation may be implemented, e.g., geographic confirmation, matching phone location with receiving device location, carrier confirmation, secondary device confirmation, etc.

At step 322, the customer may be authenticated. The authentication information may be stored in a data store or other storage mechanism. The stored information may be used in future authentication analysis. Also, the information may be used to automatically or expedite authenticate the same customer during a subsequent visit or transaction.

At step 324, the requested transaction may be initiated. If a receiving terminal is able to authenticate and verify the customer's identity, a requested transaction may be performed. According to another example, if the customer is unable to fully authenticate, the system may reject the transaction request. In another example, the customer may proceed with the request but with limitations and restrictions. Further, the customer may be closely monitored for fraud analysis.

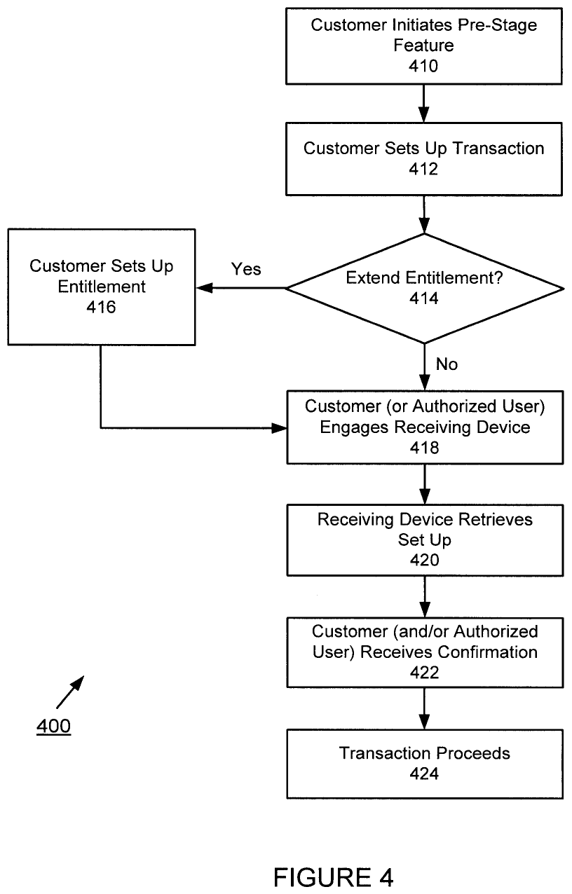

FIG. 4 is an exemplary diagram of a method for implementing a pre-stage feature, according to an embodiment of the present invention. At step 410, a customer may initiate a pre-stage function. At step 412, the customer may set up a transaction. At step 414, the customer may engage a device. At step 416, the device may receive, retrieve and/or otherwise access the set up. At step 418, the customer may receive notification and/or confirmation. At step 420, the transaction may proceed via the set up. The order illustrated in FIG. 4 is merely exemplary. While the process of FIG. 4 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

An embodiment of the present invention is directed to pre-staging ATM transactions. For example, customers may set-up a desired ATM transaction before the customer arrives at the ATM. When the customer arrives at the ATM, the customer may authenticate with their card (or cardlessly using their phone or one-time access code), then scan the mobile device on a reader, e.g., a NFC reader. The ATM may then retrieve the desired transaction the customer set-up, the customer may confirm the desired transaction. The ATM may then proceed with the transaction.

At step 410, a customer may initiate a pre-stage function. An embodiment of the present invention is directed to pre-staging transactions, such as ATM Transactions. For example, customers can use a mobile app on a mobile device to initiate a desired ATM transaction before the customer arrives at the ATM. Transactions may include banking requests, such as withdrawals, deposits, cashier's checks, reprinting of a debit card, etc. The pre-stage transactions may include multiple simple transactions as well as complex transactions.

At step 412, the customer may set up a transaction. The customer may pre-stage one or more transactions via a mobile app, a website, mobile device, phone conversation, etc. According to another example, a customer may speak a series of transactions into a mobile device, the mobile device may then convert the voice commands into a series of steps that may then be communicated to a terminal device upon user initiation. Also, a customer may pre-stage a withdrawal of $200 from a checking account in a particular denomination (e.g., 40 five dollar bills). The customer may authenticate using various methods, including debit card and PIN combination, mobile device authentication, cardless authentication, use code authentication, biometric authentication, etc.

At step 414, a customer may extend an entitlement to another authorized user. An embodiment of the present invention may also enable a customer to authorize another individual to fulfill the pre-stage transaction. In other words, a customer may extend an entitlement to another person. For example, a customer may pre-stage a withdrawal transaction and provide an entitlement to the customer's son. The customer's son may then go to an ATM machine and fulfill the pre-stage transaction. According to another example, a small business owner may pre-stage a series of deposits, some of which may be complex, and then extend an entitlement to a trusted employee. The employee may then fulfill the pre-staged deposits on behalf of the employer.

At step 416, the customer may set up the entitlement. The person may be an authorized user of the account. Also, the person may receive a token or other electronic authorization that provides the entitlement to fulfill a transaction as well as perform other actions. The customer may select or identify a person to extend an entitlement to. The customer may search through a contacts list, or enter the person's phone number, image, or other identifying information. Based on the contact information and/or other verifiable information (e.g., phone number, home address, email address, image, how long a person has been on the customer's contact list, etc.), an embodiment of the present invention may determine that the person is well known to the customer. Once the customer is identified, an embodiment of the present invention may then set restrictions as well as associate a pre-stage transaction with the customer, etc. For example, if a customer's daughter is going to watch a movie with friends, the customer may extend an entitlement to make transactions from an ATM device. The customer may pre-stage the transaction (e.g., $20 withdrawal). Also, the customer may set restrictions, e.g., withdrawals only from ATMs at or near the mall, zip code restriction, restrict withdrawal limit to $30, active only from 6 pm until 10 pm, etc. The customer may also view a video clip of the interaction from a camera or other device at the ATM terminal. Moreover, the customer may receive a notification, confirmation and/or other type of message regarding the entitlement. In this example, when the daughter makes a transaction, a confirmation notice may be sent to the customer to confirm that the transaction is authorized. The customer may then verify, deny or post another response. Also, the customer may request or forgo additional biometric or other authentication. The customer may also provide a one-time access, so that the daughter's use of the account is limited to just that one night. In another example, the customer may set a daily limit of $50.

According to another example, an embodiment of the present invention may provide customized pre-stage transactions based from the customer's historical information. The customer may then select an appropriate pre-stage transaction. An embodiment of the present invention may recognize that a customer withdraws $100 every Friday after work from a particular ATM. Accordingly, the customer's mobile device may pre-stage this transaction so that the customer can walk up to an ATM and simply confirm the withdrawal. Also, based on the customer's geographic location, the customer's mobile device may receive alerts, notifications, reminders, etc. The customer's geographic location may also be used to authenticate or confirm the customer is who they say they are. Customers may also pre-stage cash back transactions at merchants, retailers, hotels, movie theaters, service providers, etc.

At step 418, the customer may engage a receiving device. After the customer sets up a pre-stage transaction, the customer may interact with a financial device, e.g., ATM, etc. The customer's device may communicate using a wireless, contactless or radio channel. The customer may also interact with a representative, e.g., teller, etc. In this example, the customer may similarly communicate the pre-stage transaction to the representative's device. If an authorized user has been extended an entitlement, the authorized user may engage the receiving device.

At step 420, the receiving device may receive, retrieve and/or otherwise access the set up. The pre-stage information may be communicated via the wireless communication channel, which may be established using a reader on the receiving device.

At step 422, the customer may receive notification and/or confirmation. For example, the customer may receive a message confirming the pre-stage transaction. This step may be optional for some customers or transactions. In the case of an authorized user, the authorized user as well as the customer may receive confirmation. For example, while the authorized user is engaging the receiving device, the customer may receive a notification confirming the authorized user's pre-stage transaction.

At step 424, the transaction may proceed via the set up. Upon confirmation from the user, the pre-stage transaction may be initiated. Also, the transaction may proceed automatically upon establishing a communication between the customer device and the receiving device.

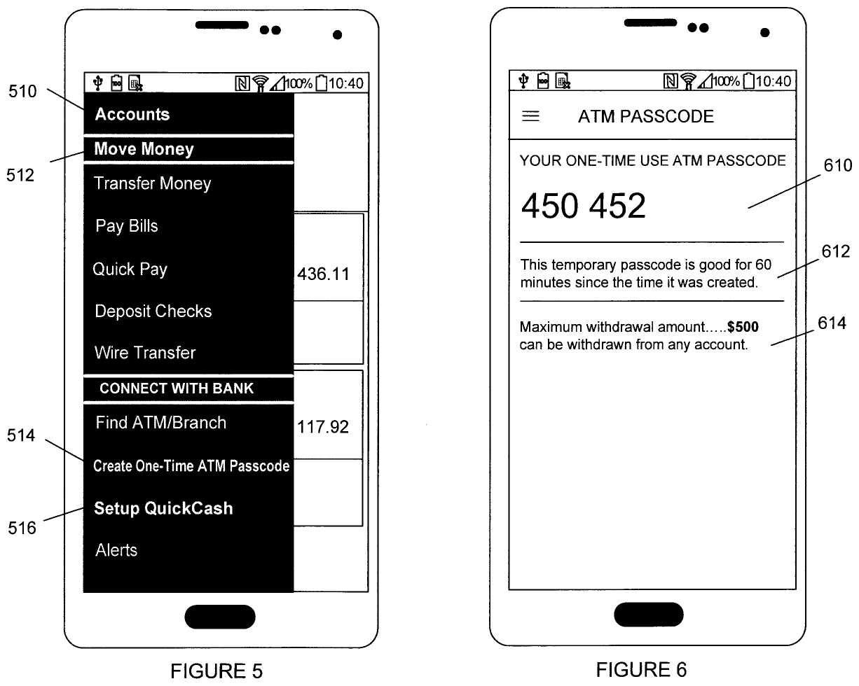

FIG. 5 is an exemplary screenshot illustrating cardless authentication, according to an embodiment of the present invention. FIG. 5 illustrates an exemplary mobile app for a financial institution. In this example, a customer may view account information at 510, account functionality at 512 and other banking related functions. Specifically, a customer may create a one-time ATM use code (or passcode) at 514. In this exemplary illustration, the use code is a for an ATM. However, the use code may be generic or specific to a particular type of transaction. The use code may be one-time use or it may be used multiple times. Also, a customer may setup a transaction at 516.

FIG. 6 is an exemplary screenshot illustrating cardless authentication, according to an embodiment of the present invention. Upon requesting a one-time ATM use code, a customer may view the use code at 610. The use code may take on various forms, including numbers, letters, alphanumeric, icons, images, etc. The customer may enter the use code, scan the use code. Also, by bringing the mobile phone within close range of a reader associated with the ATM, the use code may be communicated wirelessly. Also, the use code may be communicated without the customer's initiation when the mobile device is within range of the reader. At 612, a time restriction may be detailed. At 614, a maximum withdrawal amount may be identified. Other restrictions, constraints, warnings, qualifications may be displayed and illustrated to the customer.

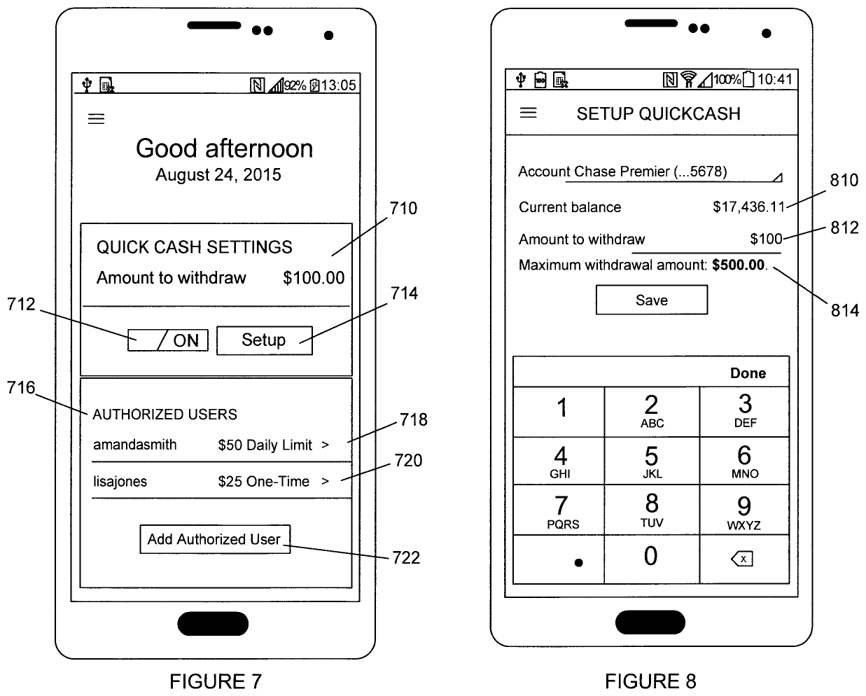

FIG. 7 is an exemplary screenshot illustrating a pre-stage feature, according to an embodiment of the present invention. In this example, a customer may set up a transaction to withdraw $100. The customer may further specify which account(s) the withdrawal takes place. The customer may also request denomination of the withdrawal (nine $10 dollar bills and ten $1 bills). The customer may further request a delayed post date. Additional details as well as additional transactions may be pre-staged. As shown in 712, the pre-stage feature may be activated. Section 714 enables a customer to set up a pre-stage transaction. Also, a customer may include authorized users, as shown at 716. In this example, there are two authorized users, which with a corresponding limit, at 718 and 720. Additional users may be identified at 722.

FIG. 8 is an exemplary screenshot illustrating a pre-stage feature, according to an embodiment of the present invention. As shown in FIG. 8, a current balance and amount to withdraw may be displayed at 810 and 812, respectively. In this example, a restriction is applied, e.g., maximum withdrawal of $500, as shown by 814.

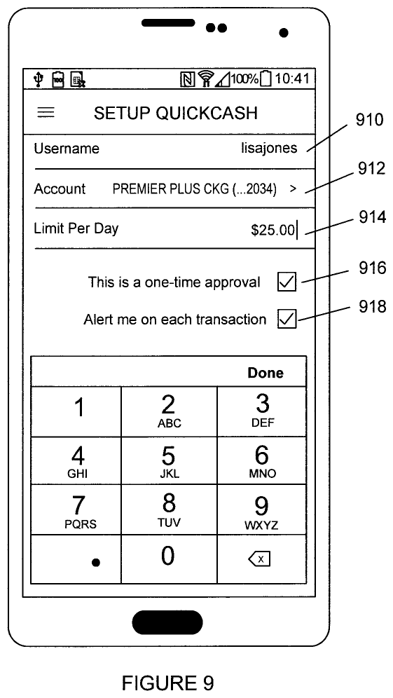

FIG. 9 is an exemplary screenshot illustrating a pre-stage feature, according to an embodiment of the present invention. FIG. 9 provides a detailed illustration of an authorized user set up. In this example, a user has been extended authorization to withdraw from the customer's account. The user is identified at 910. A corresponding account is identified at 912 and a monetary limit is provided at 914. Additional restrictions are shown at 916 (one time approval) and 918 (alert for each transaction). Other constraints, qualifications and/or restrictions may be provided.

Although the foregoing description has focused primarily on a financial institution assembling relevant data sets, processing the data, and sending the relevant data at appropriate times to its customer, the system may be operated and maintained by other types of commercial entities who may configure the system to provide similar advantages to their customers. In additional, while the foregoing description has focused primarily on the customer spend, the principles of the invention can be applied to other vendors and entities where the operating entity can assemble and provide relevant, timely information to enhance the customer's experience.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

Data and information maintained by the servers shown by FIG. 1 may be stored and cataloged in one or more databases, which may comprise or interface with a searchable database and/or a cloud database, as illustrated by 150. The databases may comprise, include or interface to a relational database. Other databases, such as a query format database, a Standard Query Language (SQL) format database, a storage area network (SAN), or another similar data storage device, query format, platform or resource may be used. The databases may comprise a single database or a collection of databases. In some embodiments, the databases may comprise a file management system, program or application for storing and maintaining data and information used or generated by the various features and functions of the systems and methods described herein.

Communications network, e.g., 102 in FIG. 1, may be comprised of, or may interface to any one or more of, for example, the Internet, an intranet, a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

Communications network, e.g., 102 in FIG. 1, may also comprise, include or interface to any one or more of a Wireless Application Protocol (WAP) link, a Wi-Fi link, a microwave link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 102 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network, e.g., 102, may comprise a satellite communications network, such as a direct broadcast communication system (DBS) having the requisite number of dishes, satellites and transmitter/receiver boxes, for example. The communications network may also comprise a telephone communications network, such as the Public Switched Telephone Network (PSTN). In another embodiment, communication network 110 may comprise a Personal Branch Exchange (PBX), which may further connect to the PSTN.

Although examples of a mobile device 130 and a personal computing device 120 are shown in FIG. 1, exemplary embodiments of the invention may utilize other types of communication devices whereby a user may interact with a network that transmits and delivers data and information used by the various systems and methods described herein. The mobile device and personal computing device may include a microprocessor, a microcontroller or other device operating under programmed control. These devices may further include an electronic memory such as a random access memory (RAM), electronically programmable read only memory (EPROM), other computer chip-based memory, a hard drive, or other magnetic, electrical, optical or other media, and other associated components connected over an electronic bus, as will be appreciated by persons skilled in the art. The mobile device and personal computing device may be equipped with an integral or connectable liquid crystal display (LCD), electroluminescent display, a light emitting diode (LED), organic light emitting diode (OLED) or another display screen, panel or device for viewing and manipulating files, data and other resources, for instance using a graphical user interface (GUI) or a command line interface (CLI). The mobile device and personal computing device may also include a network-enabled appliance or another TCP/IP client or other device. The mobile device 130 and personal computing device 120 may include various connections such as a cell phone connection, WiFi connection, Bluetooth connection, satellite network connection, and/or near field communication (NFC) connection, for example.

As described above, FIG. 1 includes a number of servers 140 and user communication devices 120, 130, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers in FIG. 1 may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, and/or JavaScript. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices 120, 130 or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although, the examples above have been described primarily as using a software application (“app”) downloaded onto the customer's mobile device, other embodiments of the invention can be implemented using similar technologies, such as transmission of data that is displayed using an existing web browser on the customer's mobile device.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A financial device comprising:
a reader configured to:
support one or more of near field communication (NFC) and Bluetooth low energy (BLE); and
receive, through a connection with the mobile device via the one or more NFC and BLE, a use code for user authentication from a mobile application on a mobile device associated with a user, wherein the mobile application is associated with a financial institution where a user holds an account;
an interactive display that displays confirmation of the use code from the mobile device;
a processor that:
authenticates the user by:
verifying the use code from the financial institution mobile application;
authenticating the user device through carrier level analysis;
identifying a security concern and requesting from the mobile device, based on the security concern, additional authentication, the additional authentication including at least one of biometric input from the user, a social security number, a zip code, and an answer to a security question;
formats the user interaction by:
identifying and applying one or more privileges specific to the user, the one or more privileges based on customer specific data associated with the authenticated user;
automatically identifying and applying restrictions specific to the user, wherein the restrictions are based on one or more of geographic boundaries, user transaction history, concerns regarding potential fraud, and a pre-staged transaction request; and
conduct a user-requested financial transaction in accordance with the identified and applied privileges and restrictions.

2. The financial device of claim 1, wherein the financial device is an Automated Teller Machine (ATM).

3. The financial device of claim 1, wherein the reader is a near field communication (NFC) reader.

4. (canceled)

5. The financial device of claim 1, wherein the processor automatically retrieves the authentication code with no user input.

6. The financial device of claim 1, wherein the interactive display is further configured to receive a manual entry of the mobile device generated authentication code.

7. The financial device of claim 1, wherein the processor retrieves a pre-stage transaction from the mobile device.

8. The financial device of claim 7, wherein the processor identifies an extended entitlement given to the mobile device, wherein the extended entitlement authorizes the pre-staged transaction.

9. (canceled)

10. (canceled)

11. A method for implementing a financial device for cardless authentication, the method comprising the steps of:
receiving, at a reader, via one or more of near field communication (NFC) and Bluetooth low energy (BLE), a use code for user authentication from a mobile application on a mobile device associated with a user, wherein the mobile application is associated with a financial institution where a user holds an account;
displaying, via an interactive display, confirmation of the use code from the mobile device;
authenticating the user by:
verifying the use code from the financial institution mobile application;
authenticating the user device through carrier level analysis;
identifying a security concern and requesting from the mobile device, based on the security concern, additional authentication, the additional authentication including at least one of biometric input from the user, a social security number, a zip code, and an answer to a security question;
formatting the user interaction by:
identifying and applying one or more privileges specific to the user, the one or more privileges based on customer specific data associated with the authenticated user;
automatically identifying and applying restrictions specific to the user, wherein the restrictions are based on one or more of geographic boundaries, user transaction history, concerns regarding potential fraud, and a pre-staged transaction request;
receiving, via a transaction processor, a transaction request from the authenticated user; and
conducting, via the transaction processor, the requested financial transaction in accordance with the identified and applied privileges and restrictions.

12. The method of claim 11, wherein the financial device is an Automated Teller Machine (ATM).

13. The method of claim 11, wherein the reader is a near field communication (NFC) reader.

14. (canceled)

15. The method of claim 11, wherein the processor automatically retrieves the authentication code with no user input.

16. The method of claim 11, wherein the user manually enters via the interactive display, the mobile device generated authentication code.

17. The method of claim 11, wherein the processor retrieves a pre-stage transaction from the mobile device.

18. The method of claim 17, wherein the processor identifies an extended entitlement given to the mobile device, wherein the extended entitlement gives the user permission for an authorized user to perform the pre-staged transaction.

19. (canceled)

20. (canceled)
